(19) United States
(12) Patent Application Publication
(10) Pub. No.: US 2006/0190806 A1
(43) Pub. Date: Aug. 24, 2006

(54) Systems and method for deploying a software application on a wireless device

(76) Inventors: David Sasson, East Windsor, NJ (US); Thaddeus Bielenda, Matawan, NJ (US)

Correspondence Address: SONNENSCHEIN NATH & ROSENTHAL LLP, P.O. BOX 061080, WACKER DRIVE STATION, SEARS TOWER, CHICAGO, IL, 60606-1080, US

(21) Appl. No.: 11/351,122

(22) Filed: Feb. 9, 2006

Related U.S. Application Data
(60) Provisional application No. 60/651,356, filed on Feb. 9, 2005.

(51) Int. Cl. G06F 17/21

(52) U.S. Cl. 715/500

(57) ABSTRACT

In an embodiment of a system and method for designing and deploying a mobile application in an online environment, defining a group and a user in an online browser client software application, creating a mobile GUI in the online browser client software application, mapping the online browser client software application to external data using a drag and drop application, formatting the external data to the GUI using the drag and drop application, and saving the group and user, the mobile GUI and the mapping information in the backend server.

### CROSS-REFERENCE TO RELATED APPLICATION

The present invention claims priority from U.S. Patent Application Ser. No. 60/651,356, filed Feb. 9, 2005, which is incorporated herein by reference in its entirety to the full extent allowed by law.

### FIELD OF THE INVENTION

The present invention relates to the field of mobile application development and deployment environments. More specifically, the present invention relates to a system and method for providing a seamless environment for developing and deploying mobile application allowing for the simplification of data delivery and presentation for enterprise and other systems. The present invention also relates to the field of development and deployment of mobile and computer applications using Internet Protocols (IP) as the primary conduit in a single online platform environment.

### BACKGROUND OF THE INVENTION

As the mobile industry has experienced over the last decade, with the constantly increasing quantity of varying communications standards and protocols and increasing quantity of mobile data applications being offered in the marketplace, the task of building and deploying a mobile data platform has become extremely complex, difficult, time consuming and costly. Moreover, with the increasing number of devices and manufacturers of devices in the market, including, for example, mobile phones, PDAs, Data collection scanning devices, laptop PCs, tablet PCs, and desktop PCs, creating an infrastructure that integrates the variety of applications with these and other devices becomes a daunting task for any programmer or IT department.

The current industry standard for accomplishing the task of creating an enterprise infrastructure incorporating a mobile data platform is to develop a mobile data application specifically for each type of device that is connected to the system. This requires that the programmers have an in-depth knowledge of the programming language for each type of device. The complications and difficulties are increased by having to install a separate SDK (Software Development Kit) to program the code for each type of device and server-side communications logic for each developer. These difficulties are compounded by the complications involved in determining how to deploy the applications once they are finally developed.

Deploying mobile applications and updating the equipment of a company's employees utilizing these applications is time consuming, costly, and prone to a variety of risks. Additionally, the developer and end-users of the applications must be aware of and familiar with each of the different communication protocols that are being utilized and are currently in place. The mobile application must also be capable of handling in real-time alerts and notifications as well as functioning in a disconnected mode as the mobile worker moves in and out of the coverage network.

These limitations of the current technology increase the difficulty of developing a wireless enterprise infrastructure, make the costs for developing such an infrastructure prohibitive and causes significant delays and time in deploying such wireless infrastructures to a company's work force.

These complexities are solved with the solution as taught by the present invention, which provides a simple online mechanism for developing and deploying applications and provide for the seamless communication with a smart agent.

### SUMMARY OF THE INVENTION

The present invention teaches a system and method for providing a seamless environment for developing and deploying mobile applications thereby allowing for the simplification of data delivery and presentation for enterprise and other systems. The present invention also teaches a system and method for the development and deployment of mobile and computer applications using Internet Protocols (IP) as the primary conduit in a single online platform environment.

By providing a smart agent that communicates to a scalable, online middleware, the present invention solves the problems of the current systems and methods and allows for the efficient, simplified and relatively inexpensive means for developing, deploying, and servicing mobile data applications through an enterprise and other environments. The present invention also teaches a system and method for developing and deploying mobile applications instantly online. In a first embodiment of the present invention, a system and method is taught that utilizes drag-and-drop technology, without the need to develop specific code, thereby providing a highly user-friendly and simple deployment capability.

Utilizing the present invention, data can emanate from virtually any source, including, for example, databases, MQ, Web Services, GPS, and enterprise business systems.

The present invention also provides a system and method for the delivery of data in systems having various configurations, including, for example, a single software application running on different platforms, a single software application running on a server and a mobile device, and between a plurality of applications running on the same or different platforms and/or devices. The present invention may accomplish the delivery of data by utilizing a smart agent client running on mobile wireless devices and applications running on computers coupled to any data source, over any network.

The present invention provides a system and method for delivering data between an application serving as a client and running on a mobile wireless device and an application running on a computer or over any network. The application running on the mobile wireless device may be an application such as, for example, a key word searching program while the application running on the computer or over a network may be an application such as, for example, an inventory management program. The mobile wireless device communicates with the computer via a wireless network.

The present invention also provides a system and method to load data into cache memory on a mobile device, which can be manipulated at any time in connected and disconnected modes.

The present invention also provides a system and method for the development and deployment of mobile applications utilizing one or more computer programs that are accessible via an Internet browser. The applications may be developed using a computer program that is accessible via an Internet browser such as, for example, Internet Explorer, Netscape or some other browser. Upon completion of the development of the mobile application, the application may be deployed to one or more mobile devices via the Internet browser interface or via some other interface, such as, for example, a wireless interface. Alternatively, pre-existing applications may be deployed or pre-existing enterprise or other logic and/or data may be utilized to build, test or deploy a mobile application.

The present invention also provides a system and method for creating and deploying mobile applications using a graphical user interface (GUI) drag-and-drop process within a Web browser and for connecting to data sources, including, for example, Databases, Web Services, MQ, Business Rules, and more, in an online platform utilizing drag-and-drop technology and running in a Web browser. Enterprise or other applications that are resident on a computer server or network may be identified by icons or some other identifier in a GUI. Each application may be copied from one location to one or more other locations by dragging the identifier for the application from a particular location and dropping or copying it into a different location. For example, a software application may be copied from a server to a mobile device coupled to the server by dragging the software application identifier from the server location in the GUI and dropping it into the mobile device location in the GUI. The mobile device may be coupled to the server, for example, via a wireless connection, a LAN or WAN connection, or an Internet connection

The present invention also provides a system and method for setting up users, groups, and security profiles online via an Internet Web browser, and an online menu system to control all functions of the software platform via a unique drop down Control Panel.

The system and method according to the present invention provides a mobility suite including a server side online platform and one or more device side smart agents that enable users to rapidly develop and deploy applications on a single platform via the Internet, as well as use smart agents on mobile devices that handle the formatting and transfer of data and presentation integrity of the data and operate in online and/or offline modes.

The present invention provides a method for deploying a software application on a wireless device having a smart agent software application and coupled to a server using a browser software application, comprising creating an identity for a user and a group to provide for access to data; creating a GUI to provide for formatting, and mapping of the software application to the data; mapping the software application to external data using a drag and drop software application; formatting the data to the GUI using the drag and drop software application; and saving the group and user, the GUI and the mapping information in the server.

The present invention also provides a method wherein the GUI includes at least one screen configuration representing a presentation layer of the software application.

The present invention provides a method further comprising providing for messaging and alert notification, for existing logic to be reused by the wireless device, for the storage of data persisting in local memory, and for mapping of the data and application functionality to a web service.

The present invention provide a method further comprising parsing the at least one screen configuration to create a lowest common denominator file.

The present invention provide a method wherein the lowest common denominator file is provided in XML format.

The present invention provide a method further comprising assigning the at least one screen configuration to a wireless device.

The present invention provide a method wherein the data emanates from a group including databases, MQ, web services, GPS, and enterprise business systems.

The present invention provide a system for deploying a software application, comprising: a wireless device having a smart agent software application; a server coupled to the wireless device using a browser software application, the server including a software program for creating an identity for a user and a group to provide for access to data, creating a GUI to provide for formatting, and mapping of the software application to the data, mapping the software application to external data using a drag and drop software application, formatting the data to the GUI using the drag and drop software application; and saving the group and user, the GUI and the mapping information in the server.

The present invention provide a system wherein the GUI includes at least one screen configuration representing a presentation layer of the software application.

The present invention also provide a system wherein the software program includes a first subprogram that provides for messaging and alert notification, a second subprogram that provides for existing logic to be reused by the wireless device, a third subprogram that provides for the storage of data persisting in local memory, and a fourth subprogram that provides for mapping of the data and application functionality to a web service.

The present invention provide a system wherein the at least one screen configuration is parsed to create a lowest common denominator file.

The present invention provide a system wherein the lowest common denominator file is provided in XML format.

The present invention provide a system wherein the at least one screen configuration is assigned to a wireless device.

The present invention provide a system wherein the data emanates from a group including product databases, MQs, web services, GPS, and enterprise business systems.

The present invention provides a computer program product for use with a wireless device, the computer program product comprising: a computer usable medium having computer readable program code embodied therein for use when deploying a software application on a wireless device having a smart agent software application and coupled to a server using a browser software application, the computer readable program code including: computer readable program code for creating an identity for a user and a group to provide for access to data; computer readable program code for creating a GUI to provide for formatting, and mapping of the software application to the data; computer readable program code for mapping the software application to external data using a drag and drop software application; computer readable program code for formatting the data to the GUI using the drag and drop software application; and computer readable program code for saving the group and user, the GUI and the mapping information in the server.

The present invention provides a computer program product further comprising computer readable program code for providing for messaging and alert notification, for existing logic to be reused by the wireless device, for the storage of data persisting in local memory, and for mapping of the data and application functionality to a web service.

The present invention provides a computer program product wherein the GUI includes at least one screen configuration representing a presentation layer of the software application.

The present invention provides a computer program product further comprising computer readable program code for parsing the at least one screen configuration to create a lowest common denominator file.

The present invention provides a computer program product further comprising computer readable program code for assigning the at least one screen configuration to a wireless device.

The present invention provides a method for deploying a mobile application developed for coupling a wireless device to a server, in an online environment, comprising: designing a wireless configuration including rules at the wireless device; validating and storing the wireless configuration at the server; compiling the rules in the server; feeding the rules to a multithreaded engine; executing rules at the multithreaded engine for at least one user; and deploying the wireless application on the wireless device.

The present invention provides a method for communicating between a wireless device and a server, comprising: registering an address of the wireless device with the server; polling the server for an alert; pushing an alert message to the wireless device; synchronizing the transfer of data between the server and the wireless device; placing the data in a queue on the wireless device; and removing the data from the queue on the wireless device upon receipt of the data by the server.

The present invention provides a method further comprising decrypting the data to provide information for GUI rendering on the wireless device.

The present invention provides a method wherein the alert is associated with an action.

The present invention provides a method wherein a user creates an alert and sends the alert with a predefined action.

The present invention provides a method wherein all data to be transmitted between the server and the wireless device is routed through a security application.

The present invention provides a method wherein the communication is accomplished over a network.

The present invention provides a method wherein the network is at least one of a wireless network and a wired network.

The present invention provides a method wherein the communication is accomplished using at least one of sockets and http/servlets.

The present invention provides a method wherein the communication between the wireless device and the server is coordinated using a middleware application.

The present invention provides a method wherein the middleware application is selected from a group including GSM, GPRS, 802.11, and iDEN.

The present invention provides a communications system, comprising: a wireless device; and a server communicating with the wireless device via a network, the wireless device including a software application that provides for registering an address of the wireless device with the server, polling the server for an alert, synchronizing the transfer of data between the server and the wireless device, placing the data in a queue on the wireless device, and removing the data from the queue on the wireless device upon receipt of the data by the server, and the server including a software application for pushing an alert message to the wireless device.

The present invention provides a communications system herein the software application further provides for decrypting the data to provide information for GUI rendering on the wireless device.

The present invention provides a communications system wherein the alert is associated with an action.

The present invention provides a communications system wherein a user creates an alert and sends the alert with a predefined action.

The present invention provides a communications system wherein all data to be transmitted between the server and the wireless device is routed through a security application.

The present invention provides a communications system wherein the communication is accomplished over a network.

The present invention provides a communications system wherein the network is at least one of a wireless network and a wired network.

The present invention provides a communications system wherein the communication is accomplished using at least one of sockets and http/servlets.

The present invention provides a communications system wherein the communication between the wireless device and the server is coordinated using a middleware application.

The present invention provides a communications system wherein the middleware application is selected from a group including GSM, GPRS, 802.11, and iDEN.

The present invention provides a communications system further comprising a memory, the memory storing the data being accessed by the wireless device.

The present invention provides a computer program product for use with a communication system, the computer program product comprising: a computer usable medium having computer readable program code embodied therein for use when facilitating communication between a wireless device and a server, the computer readable program code including: computer readable program code for registering an address of the wireless device with the server; computer readable program code for polling the server for an alert; computer readable program code for pushing an alert message to the wireless device; computer readable program code for synchronizing the transfer of data between the server and the wireless device; computer readable program code for placing the data in a queue on the wireless device; and computer readable program code for removing the data from the queue on the wireless device upon receipt of the data by the server.

The present invention provides a communications system further including computer readable program code for decrypting the data to provide information for GUI rendering on the wireless device.

### BRIEF DESCRIPTION OF THE DRAWINGS

FIG. 1 shows a functional configuration of a first embodiment according to the present invention.

FIG. 2 shows a configuration of the system according to a first embodiment with a hardware apparatus coupled to the BackEnd Server.

FIG. 3 shows the functional flow of a configuration process according to an embodiment of the present invention

FIG. 4 shows the launching of a mobile smart agent on a mobile device according to an embodiment of the present invention

FIG. 5 shows a unique menu system as part of the GUI interface according to an embodiment of the present invention

FIG. 6 shows an embodiment of the present system as installed in a warehouse to remotely and/or wirelessly control a conveyor system.

### DETAILED DESCRIPTION

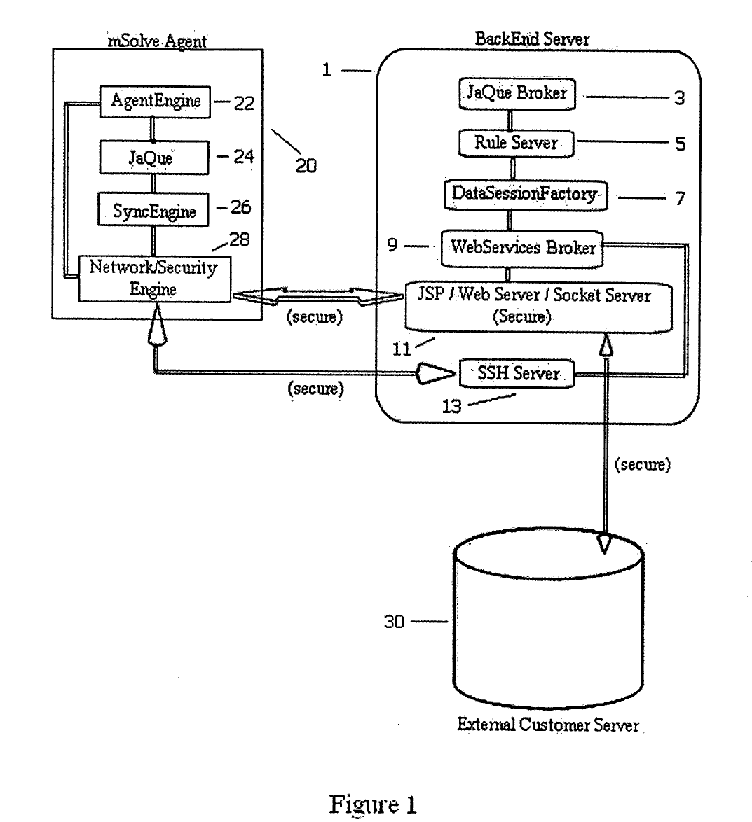

The present invention provides a system and method for enabling an enterprise to build, test and deploy a mobile application for virtually any mobile device utilizing existing enterprise logic and data. According to a first embodiment of the present invention as shown in FIG. 1, this may be accomplished, for example, by deploying a BackEnd Server incorporating certain components.

A BackEnd Server 1, which incorporates a computer software program that provides for communication with one or more mobile devices and connects them to existing data and logic from an enterprise, includes a number of components, including a JaQue Broker 3, a Rule Server 5, a Data Session Factory 7, a Web Services Broker 9, a JSP/Web Server 11 and aSSH Server 13.

The JaQue Broker 3, provides messaging and alert notification functionality. It includes a message queue engine that allows for the reception and transmission of and interaction with messages from a message queue. The JaQue Broker 3 is a message oriented middleware (MOM) and complies with the JAVA Messaging Service (JMS) specifications. The JaQue Broker 3 is also responsive to and responsible for the delivery of real-time alert notifications to remote users, thereby providing a communications link and maintaining real time or near real time communications channels and connectivity.

The Rule Server 5 provides for the compilation, validation, deployment and response to server side rules for one or more mobile configurations. In the present embodiment it has been designed as a software component but may also be designed as a hardware component or combination of hardware and software. The Rule Server 5 provides for introspection and import of Java's JAR files, Windows DLL files and Linux .SO files for the purpose of allowing existing logic to be reused by the backend server 1, thereby simplifying system setup and configuration. The connection of the back end logic to the mobile device is accomplished by creating a defined rule and coding a connection between the defined rule and existing logic.

The Data Session Factory 7 provides for the storage of any data persisting in local memory that was used in the conveyance of data from one program to the next. This component has been designed as a software component but may also be designed as a hardware component or combination of hardware and software. The Data Session Factory 7 allows a user to store data identified by a unique key. Data is stored in local memory with a time stamp such that if it is not accessed within a predefined amount of time the memory location in which it is stored is released from the computer's physical memory thereby preventing memory leaks and actively optimizing the system as it runs. The Data Session Factory 7 also publishes the internal data located in the local memory to one or more system administrators securely thereby allowing the administrators to assist a user in testing its configuration by looking for corrupt data with an online GUI tool. The GUI tool provides for the publishing of the data stored in the local memory for each individual user that utilizes local memory. The GUI tool shows a tree list of all objects in memory for a particular user and allows each user to drill down to the specific data for that user contained in local memory.

The Web Services Broker 9 provides for the automatic mapping of the data and application functionality to any web service thereby allowing the BackEnd Server 1 to communicate seamlessly with one or more mobile devices. See, for example, http://www.w3.org/2002/ws/, which is incorporated herein by reference. The Web Services Broker has been designed as a software component but it can also be provided as a combination of hardware and software. The Web Services Broker 9 reads a WSDL file from a URL and presents all application methods and parameters contained in the WSDL file on a GUI screen. This presentation of the application methods and parameters allows a user to utilize drag and drop capabilities without the need for additional coding to copy data from a web service by retrieving and transferring results, regardless of the complexity of the application methods or the results of any processing.

The JSP/Web Server 11 is an external component generally in the form of a software application, that is generally commercially available and not a component unique to the present invention. Examples of such applications are Apache/Tomcat, BEA WebLogic and IBM WebSphere. This component provides for the processing of mobile smart agent requests via http/servlet communication.

The SSH Server 13 provides for the use of a mobile device by a system administrator for communicating with and running a SSH daemon that allows for the remote administration of back end servers, as needed.

As also shown in FIG. 1, a Smart Agent 20 is coupled to the BackEnd Server 1 via one or more secure connections. The Smart Agent 20 includes a number of components, including an Queue Engine 22, a JaQue Engine 24, a Synch Engine 26, and a Network/Security Engine 28. The Smart Agent 20 has been designed as a software program that is installed on a mobile device allowing it to communicate with the BackEnd Server 1. The Smart Agent 20 may provide at least two types of connections, such as, for example, via sockets or via http/servlets. It includes built-in security features such as, for example, default SSL as well as AES advanced schemes for banking or military applications based on the Rijndael scheme, and provides end-to-end security for all data transmissions. The Smart Agent 20 includes the JaQue Engine 24 that provides for the polling of the server for any alerts and for registering the current address of the mobile device with a peer server so as to allow the pushing of alert messages. The feature of alert messaging is built into the default message engine thereby allowing an alert to be displayed. Additionally, there is functionality allowing a user to associate an alert with an action. The user may create an alert and send that alert with a predefined action, thereby allowing the user to interactively respond to an alert with the predefined choices.

The Smart Agent 20 incorporates synchronization technology, in the form of a Sync Engine 26, for ensuring that information transfer is time matched and synchronous, guaranteed message delivery technology to ensure that messages are properly delivered to the target, and a debug mechanism to help resolve mobile operational and functional issues via a help desk. The Smart Agent 20 places all transactions to be sent over the network into the Queue Engine 22 on the mobile device. The Queue Engine 22 feeds messages to be sent to the BackEnd Server 1 to the Network/Security Engine 28. The coupling of the Smart Agent 20 to the BackEnd Server 1 is accomplished via a communication link between the Network/Security Engine 28 and one or more of the SSH Server 13 and the JSP/Web Server 11. This communication link may be via a wired link or wireless connection.

When a message is successfully received by the BackEnd Server 1, the transaction is de-queued in the Queue Engine 22. This mechanism guarantees delivery of data. The Smart Agent 20 decrypts the XML data that it receives and interprets the messages included in that data so as to deliver the proper screen flow and GUI rendering as designed by the user in the online mobile design environment. Communications between the Smart Agent 20 and the BackEnd Server 1 are coordinated as with any network communication, i.e., through the middleware on any TCP/IP network, including, for example, GSM, GPRS, 802.11, iDEN, and many more network types.

As shown in FIG. 1, the BackEnd Server 1, may be coupled to an External Customer Server 30 via a secure or unsecure connection. The external Customer Server 30 may be the location where the data being accessed by the mobile device is stored.

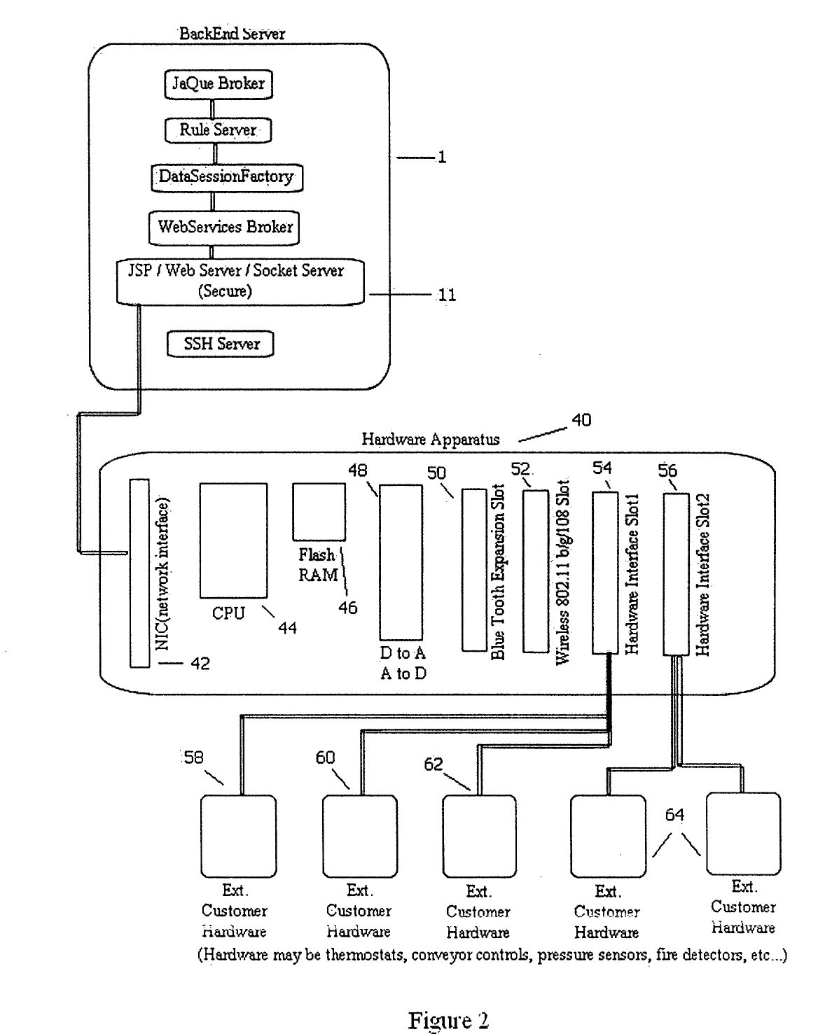

Now looking at FIG. 2, there is shown a configuration of the system according to a first embodiment with a hardware apparatus coupled to the BackEnd Server 1. The hardware apparatus 40 acts as an on premises interface for control of one or more hardware devices. The hardware apparatus 40 includes a network interface 42 for communicating with the network over which communications to and from the BackEnd Server 1 will be transferred, a CPU 44 for controlling the hardware apparatus 40, a flash RAM 46 for storing application programming code and a digital to analog and analog to digital converter (A/D converter) 48 for converting RF communications and other analog signals into digital format and vice versa. The BackEnd Server 1 acts as the intermediary between a mobile device and the hardware apparatus 40 providing for the transfer of communications between the mobile device and hardware apparatus 40, thereby allowing remote monitoring, control, querying and interfacing with the hardware apparatus 40 by the mobile device.

The hardware apparatus 40 may also optionally include a Blue Tooth expansions slot 50 for enabling communications with Blue Tooth compatible hardware, and a wireless 802.11b/g/108 slot 52 for enabling communications with 802.11b/g/108 compatible hardware. The hardware apparatus 40 may also optionally include additional hardware interface slots, such as, for example, hardware interface slot1 54 and hardware interface slot2 56 for enabling communications with external hardware components, such as, for example, a thermostat 58, conveyor control 60, pressure sensor 62, fire detectors 64, etc.

The network interface 42 can be any type of standard network interface as used to communicate with any wireless or wired network. Communications are routed between the JSP/Web Server 11 of the BackEnd Server 1 and the network interface 42. All communications are processed internally by the CPU 44 of the hardware apparatus 40 in accordance with an application program as stored in the flash RAM 46, and received signals are converted from analog to digital by the A/D converter 48 under control of the CPU 44. The hardware apparatus may in turn communicate with one or more external hardware devices via a wireless communications protocol, such as, for example, Blue Tooth, 802.11b, 802.11g, or some other IR or RF platform. The hardware devices may range from a thermostat 58 for purposes of building maintenance and control to a fire detectors 64 for building safety and monitoring, a conveyor control 60 for manufacturing plant or inventory control or a pressure sensor 62 for process control.

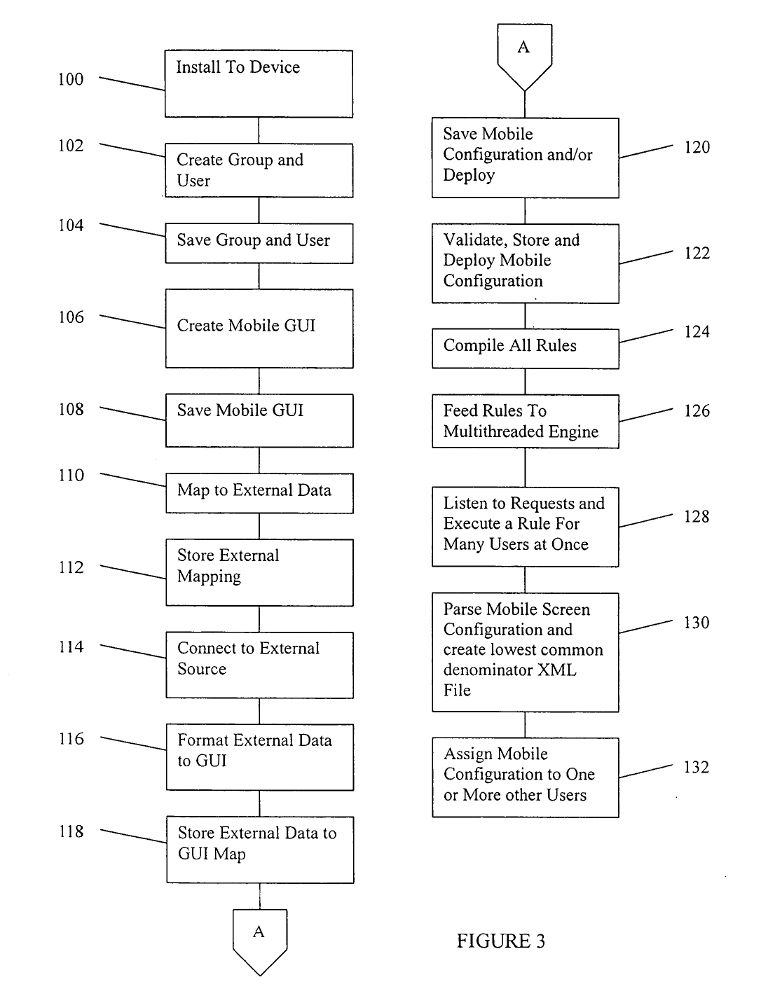

In FIG. 3 is shown a process according to an embodiment of the present invention for programming and utilizing a mobile device having a smart agent mobile software product, a computer software product and a connection to an external data source. In step 100 a mobile device is first loaded with a smart agent mobile software product (smart agent). The smart agent may be loaded to the mobile device via OTA (over the air) technology or via fixed cable. Utilizing the smart agent, the user may create a mobile application using the mobile device coupled to the BackEnd Server using an online browser. In step 102, the user creates identities for a user and a group to which the user belongs for purposes of access and communication security, and in step 104 saves the user and group identities. A mobile GUI is created in step 106 to provide for the creation of flows for mapping and formatting of data, and the mobile GUI is saved in step 108. A user may create mobile GUI screens to represent the presentation layer of the mobile application. In such a GUI environment programming is virtually eliminated by using drag and drop technology.

In step 110, data for the mobile application may be mapped online via a GUI drag and drop interface from external sources such as, for example, a database, a web service, a message queue (MQ) and enterprise java beans (EJBs). A user may map any external data sources to the mobile GUI screens via drag and drop technology. The mapping of the external data is stored in memory in step 112, and in step 114 a connection is made to the source or sources of external data.

In step 116, data may be intelligently manipulated and formatted, for example, by using an online editor to write server side business rules in a variety of languages, such as, for example, Java, C/C++, C# and Visual Basic, or any other known or future computer language, protocol or format. The user may add one or more rules to one or more actions of any mobile GUI screen and such formatting and rules may be stored in memory in step 118. In step 120, the user may save and/or deploy the mobile configuration. The BackEnd Server is invoked when the user indicates that a mobile configuration is to be saved and/or deployed, and in step 122 the BackEnd Server validates that all configurations are valid and stores the mobile configurations. In step 124, the BackEnd Server will compile all rules to native code and in step 126 feed them to a multi-threaded engine. In step 128, the multi-threaded engine will listen to requests for a native rule to be executed and may simultaneously execute a rule for many users at one time when invoked.

In step 130, the mobile screen configuration is parsed and a lowest common denominator XML file is created. The lowest common denominator file is in XML format but containing short tags and binary data to represent the configuration the user created in the smallest file size possible. It is a lowest common denominator file because it is guaranteed to operate across all mobile smart agents from a small J2ME cell phone to a medium sized Pocket PC to a full sized laptop application. The user creates one flow and it will work across all devices. In step 132, the user may then assign the mobile configuration to one or more other users.

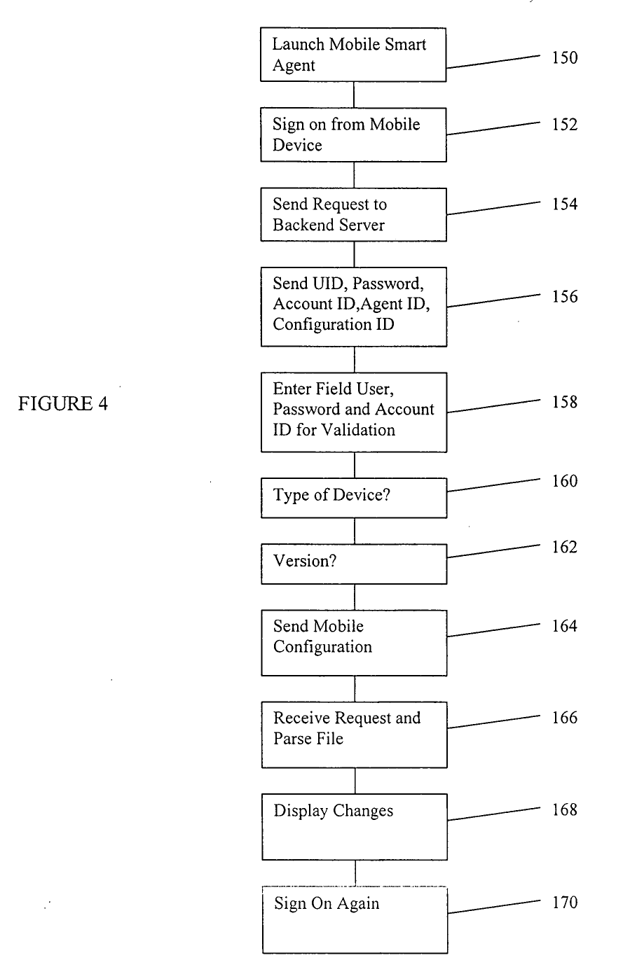

In FIG. 4 is shown the launching of a mobile smart agent on a mobile device according to an embodiment of the present invention. In step 150, a mobile work force may launch the mobile smart agent on their devices. The mobile users may sign on to the system from the mobile device in step 152, and in step 154, the mobile device sends a request to the BackEnd Server either via sockets or via http/servlet protocol depending upon which agent was loaded on the mobile device. The message sent over the network will contain an XML formatted data set. In step 156, the smart agent will send a user identification string, a password string, an account identification string, an agent identification string to tell what type of agent the request is made for and a current mobile configuration identification string to tell what version of the configuration is on the mobile device.

In step 158, the BackEnd Server fields the user/password/account combination for validity. In step 160, the BackEnd Server discovers what type of mobile device is asking for a mobile configuration, and in step 162 checks what version currently exists on the mobile device. In step 164, the BackEnd Server sends the appropriate mobile configuration to the mobile device as an XML file. In step 166, the mobile device receives the request and parses the file to load the first screen defined in the flow designed by the user online. In step 168, any changes made to the configuration are instantly deployed to the device once the user saves the mobile configuration online, and in step 170 the mobile user signs back on to the mobile device.

The present invention may be implemented as a browser based system that will allow applications to be created completely on-line within the browser. No downloading of an SDK or IDE is necessary. The system allows a new user to sign-in or create a new account. The sign on process takes an account as an extra parameter to allow the administrator of the account to add new user and assign security

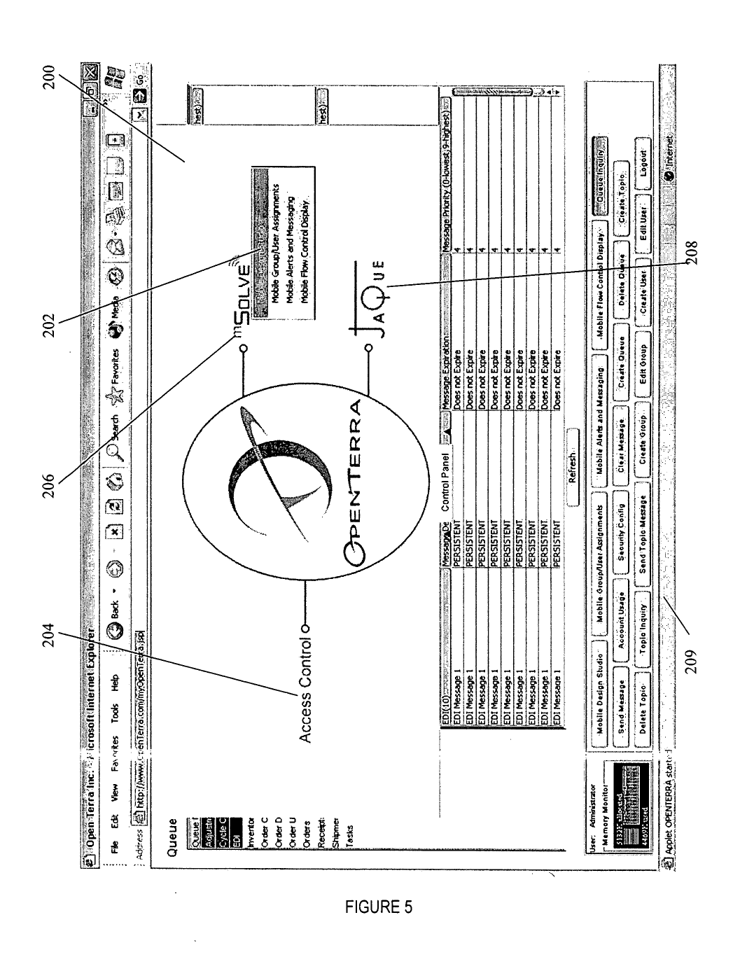

As shown in FIG. 5, a unique menu system is provided as part of the GUI interface. Utilizing a software component that allows a user to create, deploy and test mobile solutions online within a GUI drag and drop environment, the present invention provides accessibility to various screens through the use of a unique menu system that is configured and depicted as a window shade 200. The window shade 200 menu configuration is such that a user can drag the window shade 200 from one part of the user screen area to another thereby exposing menu items 202 that appear rolled up into the window shade 200. Menuing using the window shade 200 as a control panel allows a user to easily and efficiently navigate through the system menus. The window shade 200 provides for the invocation of all internal operations of the various applications resident on the BackEnd Server or at the external customer server. The mobile configurations according to an embodiment of the present invention are designed in a GUI drag and drop flow environment thereby requiring the user to first create a flow that would be accommodating to all devices. Upon creation of such a flow, the user may then choose to go to an advanced form factor area to further enhance the flow to meet the specific properties of the mobile device being utilized. For example, by moving the cursor over the icon labeled Access Control 204, an administrator is provided with a menu of administration items, that allow the administrator to add or edit users in the account, view monthly bandwidth usage for the account and manage network security. As another example, by moving the cursor over the icon labeled mSolve 206, a user will be presented with a menu that provides for a user to gain access to the mSolve Design Studio, the software program that allows users to design their mobile applications. It also allows user to deploy their applications to a mobile device. This menu provides an area to view the application flow graphically and allows interactive text messaging to be sent to one or more devices over one or more carriers and/or one or more networks. The next icon, JaQue 208, opens a menu that allows a user to access a program that provides for implementation of JMS for message queuing. The present invention is not dependent on any third party application for deployment of message queuing. JaQue may be replaced with another application, such as, for example, IBM's MQ Series or similar JMS products for a larger enterprise customer. The window shade 200 may be used as a main menu or individual menu items may be dragged and dropped into a bottom section of the window 209 to customize to a user's preferences and/or commonly used menus or menu items. The application designer may be opened at any point to design an application.

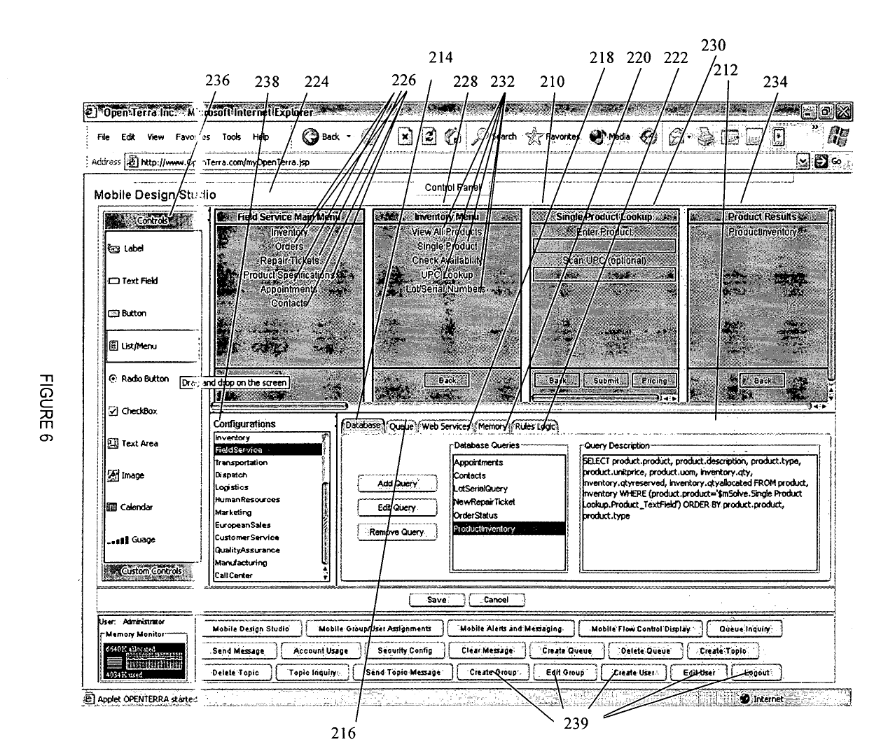

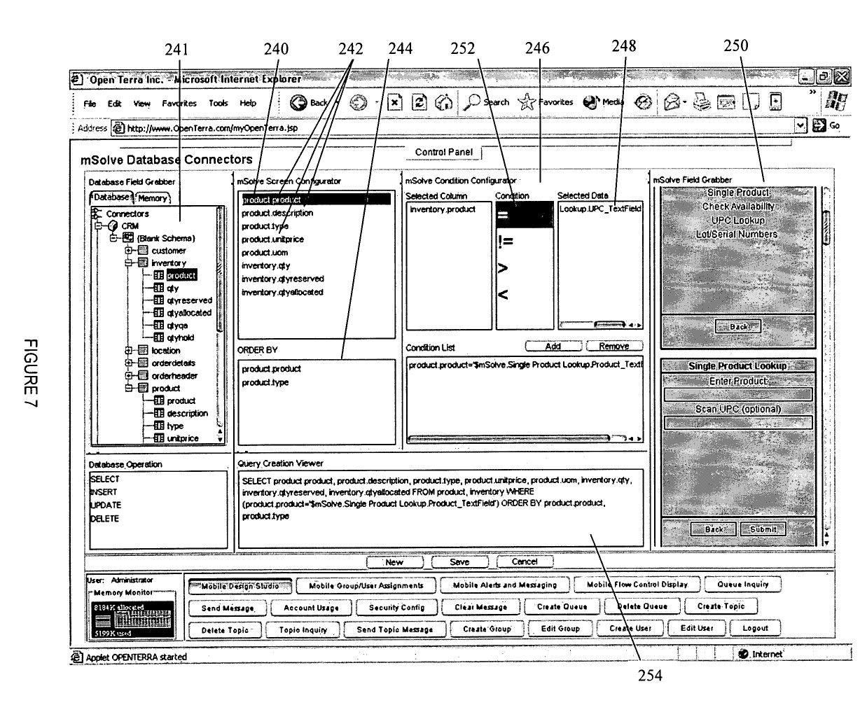

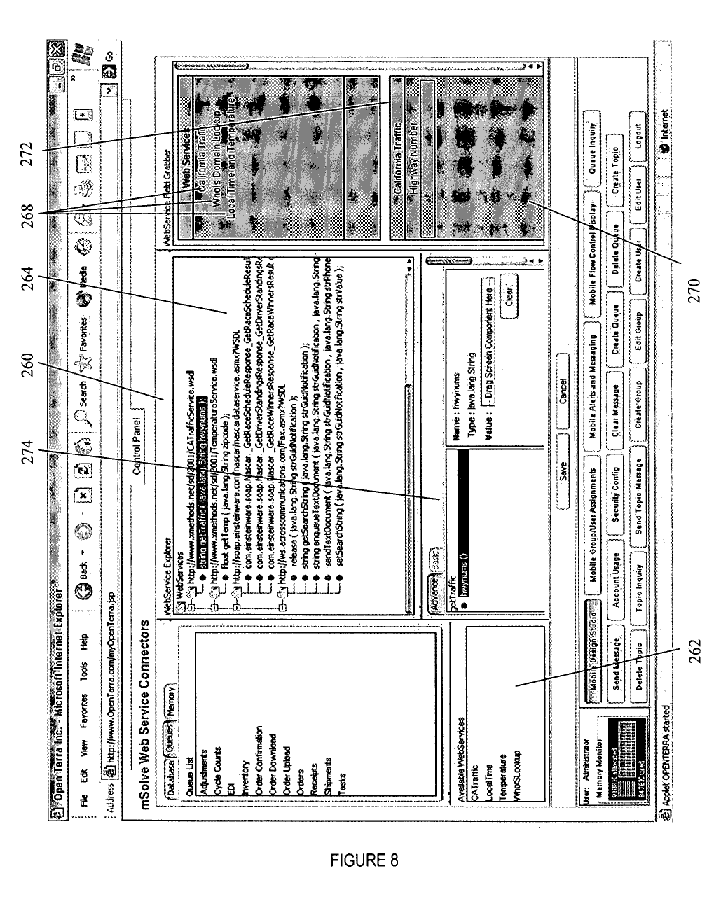

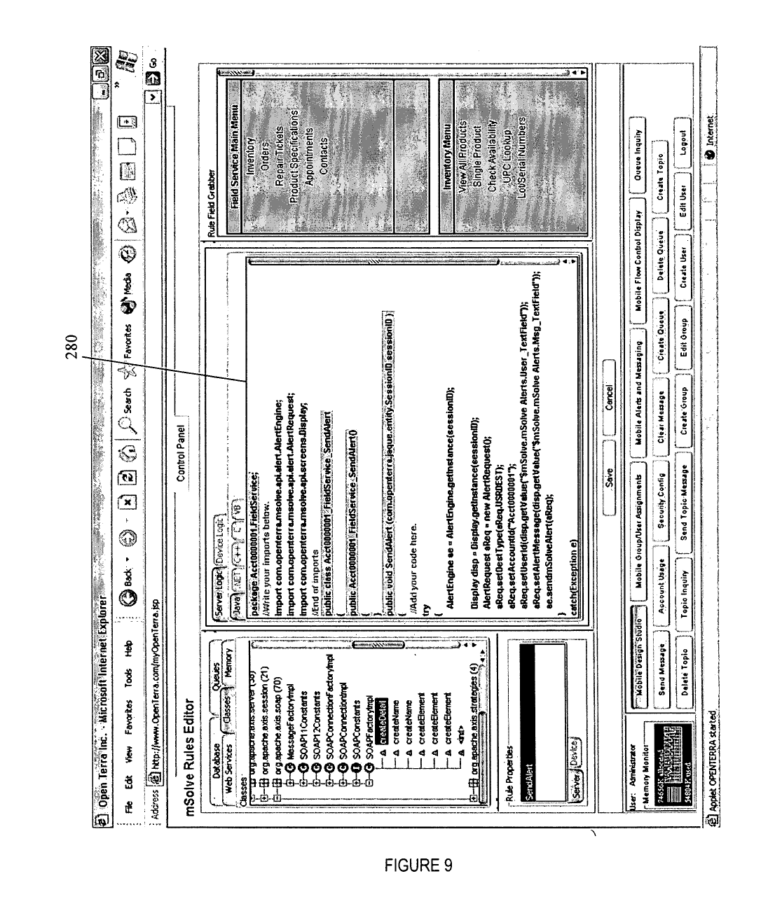

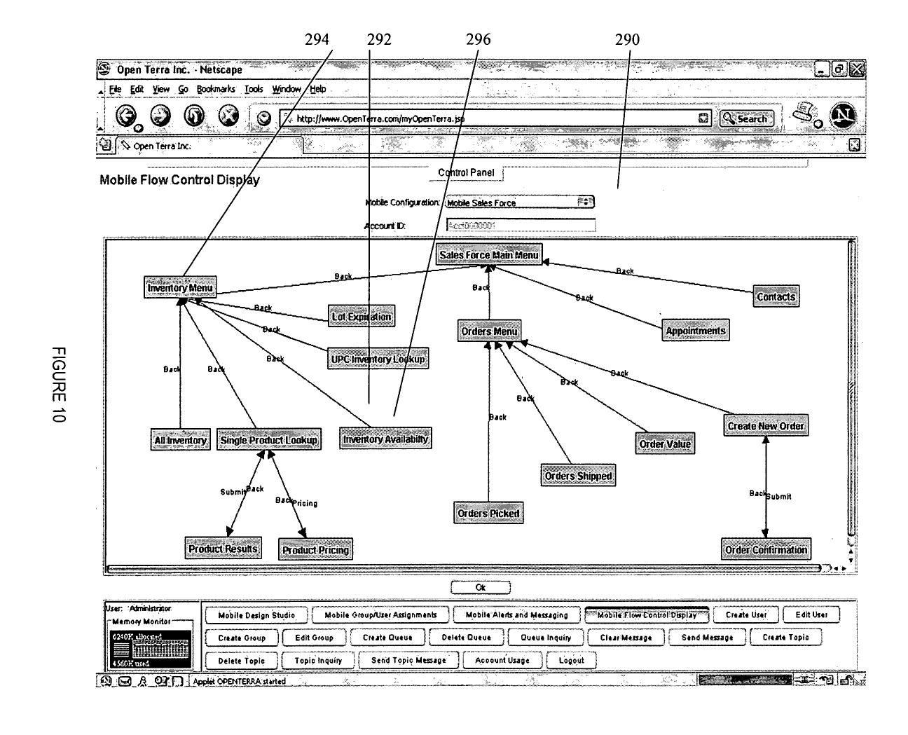

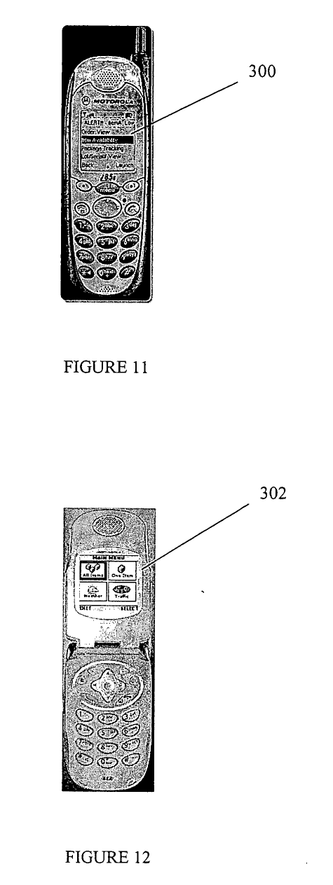

For example, as shown in FIG. 6, the operations to be embedded within the mobile device may be configured using a drag and drop flow environment where each menu layer is laid out on the display screen 210 in ascending levels of progression. The system according to the present invention obtains external data via its built in connectors. The five tabs in the query window 212, labeled Database, Queue, Web Services, Memory and Rules Logic provide connections to the various external inputs to the system. Clicking on the Database tab 214 will allow the user access to a program that allows the user to create a connection to any JDBC compliant database on any TCP/IP network. It also allows the user to access a GUI environment that provides for the dragging and dropping of database tables to create SQL. The program also allows a user to drag the database logic to a mobile application screen thereby transferring all of the work that was accomplished by the user to the mobile environment.

The Queue tab 216 reveals a list of queues that may be dragged from the list and dropped into any mobile application screen. A queue may be created by opening the window shade 200 and selecting JaQue 208. From the menu that is then displayed the item queue and then submenu item create queue are selected. A GUI is presented that allows a user to then create a name for the queue, and select private or public, and populate the queue with data. A queue inquiry may then be used to confirm proper setup of the queue. The queue that is created will then be found on the Queue tab 216 list and it may be dragged to a screen to be displayed on a mobile device.

The Web Services tab 218 allows a user to access to any published web service of any type. The program provides a GUI environment for a user to drag parameters to and results from a web service to create logic for the web service. The web service logic may then be dragged from here and dropped in a mobile screen configuration. The Memory tab 220 allows a user to access an internal memory variable. This Memory tab provides a user with access to a GUI environment to create a memory variable that has the scope of a signed on mobile device. This variable may be used if the program needs to be dynamic or obtained from another source. The user may set the value of a memory variable or use “Rules Logic” to set the value from a different program or application. An example, is where a label is created where the user name is not known at the time of making the application on the mobile screen.

The Rules logic tab 222 allows access to rules that are the system's implementation of business rules. Rules may be added to any mobile screen or to the controls on a mobile screen by right clicking and adding a rule. Rules may be added in a native language, such as, for example, Java, C++, C, etc., and there is no requirement or need for a translational tool. This area acts as a summary of all rules and there is no drag and drop into or out of this area.

The first level, or main menu 224, is positioned on the left side of the screen. Each of the selections 226 on the main menu 224 defines a separate second level menu 228 to the right of the main menu 224. Each of the second level menus is designed and constructed independently. The selections 226 are defined by the user and correspond to the features of the enterprise system that the user wishes to implement on the mobile device. A third level menu 230 is located to the right of the second level menu 228. Each third level menu is designed and constructed independently and each further defines a second menu item 232. This progression of menus continues until the bottom level is reached. A final display screen 234 is defined to show the results of the interactive session. For example, where the third menu level is a product lookup or search screen, where information may be entered by the user for a search of a company database, the final menu level will be a display screen 234 showing the results of the search. These screens and the presentation parameters of the screens may be set by the user by dragging and dropping various control elements from the controls menu 236.

Various menu configurations may be implemented by selecting from the configurations menu 238. Additionally, various queries for the different types of configuration will be displayed as query window 212 upon selection of a particular configuration. There is no coding required and, as described above, each element incorporated into the mobile GUI may be implemented and SQL code automatically generated by using a simple drag and drop tool incorporated into the window by the software. There are also provided buttons 239 at the bottom of the screen for quickly changing between menus that may be accessed by the user for designing the mobile configuration and transferring the enterprise application to a mobile platform.

As shown in FIG. 7, the system according to the present invention incorporates database connectors to various database products, including, for example, Oracle, Microsoft SQL Server, mySQL, PostgreSQL, Informix, DB2 and Sybase, among others. Connecting to a database may be accomplished by dragging and dropping data elements to correspond with the menu screen flows on the mobile device. The mobile screens are configured using the screen configurator menu 240 and selecting elements from the Database Field Grabber menu 241 to be dragged and dropped into the screen configurator menu 240 to be configured. Items are generated in the Database Field Grabber Menu 241 by linking to the server or internal computer system and/or the various databases that are available to access. The items that are displayed in the screen configurator menu 240 are the items that may be displayed on the mobile device. The order of the elements 242 that are displayed is controlled by dragging and dropping from the screen configurator menu 240 into the Order By menu 244. The scope of what will be displayed is set or conditioned using the condition configurator 246 where each element may be conditioned with respect to selected data fields 248 by dragging items from the appropriate mSolve Field Grabber menu 250 and dropping them into the selected data field 248 and applying a condition parameter 252 to define the set of information responsive to the inquiry. The description of the query and display parameters can be viewed in the Query Creation Viewer field 254 for easy review. The order by which the items responsive to an inquiry are to be displayed on the mobile device may be set using the Order By menu 244.

As shown in FIG. 8, mobile applications may be easily connected to existing web services. The WebServices Explorer 260 maps the various WebServices identified in the lower left window Available WebServices menu 262. The WebServices are mapped as a tree 264, and can include, for example, a variety of data sources, including queues and databases. Web services may be added to the tree by connecting to the web service and copying the link and pasting into the WebServices menu 262. The system then reaches out to the web site and downloads the web service thereby allowing it to become a simple drag and drop. A WebServices Field Grabber menu 266 is created, that includes menu items 268 corresponding to each of the entries in the Available WebServices menu 262. An inquiry screen 270 may also be provided, here shown as a Control Traffic screen 272, where a data inquiry can be made for return of relevant data or direction to a correct web page. As shown in the WebServices input parameters window 274 under the WebServices Explorer 260, the mobile connections can be designed by drag and drop operations for mapping the web services to the inquiry screen 270. A WebServices output parameters window (not shown) displays the items dragged from an output tree area (not shown) that are to be displayed on the mobile device. These items may be renamed, saved and dragged and dropped into a display window for a mobile device as provided in the Mobile Design Studio (as shown in FIG. 6).

The system also provides for connection to a statistics engine to track system and application usage by mobile device users. As shown in FIG. 9, the system according to the present invention provides for a Rules Editor. For example, a rule may be created to track how many searches are performed by mobile device users. Rules may be created using the Rules Editor which, unlike most rules engines, allows code to be written in any native language without the need to learn a new programming language. This removes learning curves and allows for faster processing times for processing the logic. Available languages include Java, .NET, C++, C and VB. Code may be written in the programming window 280 and the Rules Editor checks the code for errors and sends a flag if errors are detected. Once the rule is saved, the rule is applied each time the button is pressed on the mobile device.

The mobile application that is created may be deployed to all members of an administrative group or to each member individually.

Changes to a program may be applied dynamically, by entering the changes, for example, adding a new option in a menu, and saving the change. Upon entering save, the change is automatically deployed. If the change is used to add web services, the program automatically checks for and shows if there are dead links.

On the emulator side, the user merely needs to sign out and sign back in to automatically access the latest application updates.

Important messages may be delivered to all or only some users and devices, irrespective of the network (e.g., LAN, WAN, cellular, etc.) and/or device (e.g., PDA, Cell phone, notebook, RIM, etc.). To access this feature, the window shade 200 is opened and the user opens the mSolve menu and selects the mobile alerts and messaging item. A dialog box is provided for entering the information relating to providing the notification. When entered the notification is then sent and delivered to the mobile devices and scrolled at the top of the device above the menu. The system may also provide for a reply by the mobile device user to the message.

As shown in FIG. 10, after an application is created, or during creation of an application, the Mobile Flow Control Display 290 may be accessed to obtain a view of the application in an entity relationship diagram. The diagram graphically displays the interactions between screens, for example, between menu screens, query screens and/or display screens. Using the Mobile Flow Control Display 290, the application designer can easily view the interactions and connections between items and observe whether there are any missing links or incorrect connections. For example, the application designer can detect whether the connection 292 between the Inventory Menu 294 and Inventory Availability 296 exists and is properly set.

The advanced form factor area is implemented as a software component that resides in the online browser of the mobile device. It is a web based tool that allows a user to take a basic screen configuration and further customize it to meet the limitations and benefits of a particular mobile device with a particular smart agent installed. Using the advanced form factor, the system provides for the adjustment of form factors to a specific device's capabilities, or to third party controls, including, for example, for a camera phone bar code scanner or some other device, using the advanced mode. An mSolve Agent is used to make a custom form factor to be deployed to mobile devices running this selected mSolve Agent. All devices with this mSolve Agent could have a different look than those with the standard form factor. The standard form factor is dragged to the working area and modified as desired. For example, a user may take a basic mobile configuration displayed as a text menu 300 as shown in FIG. 11, and convert it to all image buttons 302 as shown in FIG. 12. The advanced form factor area will provide for the creation of a second XML file sent as an override to the basic flow to describe the graphical renderings selected for a particular device. The advanced scripts that provide for such graphical renderings are delivered to the smart agent by the BackEnd Server which decides which scripts to deliver based upon the identity of the smart agent type installed.

The interaction of the mobile device having the smart agent installed communicating through the BackEnd Server enables any JMS message queue (MQ) system to directly communicate with hardware components. For example, utilizing the configuration as shown in FIG. 2, the present system may be installed in a warehouse to remotely and/or wirelessly control a conveyor system. A user having a mobile device with a smart agent installed is able to directly control a conveyor system in a warehouse by mapping sensors 62 and conveyer control 60 to the hardware apparatus 40, then creating a queue and mapping its data to a rule which will display certain control information on the mobile screen. The user may then interact with the mobile device using a GUI to generate signals that are transmitted through the BackEnd Server 1 to the hardware apparatus 40 and from there to the conveyer control 60 for control of the conveyor system.

The system and method according to the present invention allows mobile configuration designers to connect mobile devices to external data sources. These external data sources may include, for example, Databases, WebServices, enterprise java beans (EJB), Memory and Message Queues, to name just a few.

The system may be connected to any JDBC compliant database. An online GUI may be utilized to automatically create SQL for the specific database used. The system also provides for connection to any online web service and automatically introspects the WSDL provided by such web service. The mobile device will show a GUI screen with parameters and results in a drag and drop fashion allowing a user to map complex web services to mobile screens in an abbreviated period of time. Connection to EJB may be accomplished by publishing the EJB as a web service or by connecting to the BackEnd Server with a supplied library via a rules engine. The mobile device may also be connected to the internal system memory.

Additional functionality allows a user to create a rule that interacts with data and manipulates the data before presentation of the data. The user may transfer the data to a local memory where it is automatically placed in a specific location known as the DataSessionFactory. Subsequently, the data may be easily retrieved from DataSessionFactory by the mobile device and displayed on the screen of the mobile device. The system according to the present invention also provides for the connection to any JMS compatible message queue system and provides for the mapping of the data to a mobile screen via drag and drop technology.

What is claimed is:

1. A method for deploying a software application on a wireless device having a smart agent software application and coupled to a server using a browser software application, comprising:
creating an identity for a user and a group to provide for access to data;
creating a GUI to provide for formatting, and mapping of the software application to the data;
mapping the software application to external data using a drag and drop software application;
formatting the data to the GUI using the drag and drop software application; and
saving the group and user, the GUI and the mapping information in the server.

2. The method according to claim 1, wherein the GUI includes at least one screen configuration representing a presentation layer of the software application.

3. The method according to claim 1, further comprising providing for messaging and alert notification, for existing logic to be reused by the wireless device, for the storage of data persisting in local memory, and for mapping of the data and application functionality to a web service.

4. The method according to claim 2, further comprising parsing the at least one screen configuration to create a lowest common denominator file.

5. The method according to claim 4, wherein the lowest common denominator file is provided in XML format.

6. The method according to claim 2, further comprising assigning the at least one screen configuration to a wireless device.

7. The method according to claim 1, wherein the data emanates from a group including databases, MQ, web services, GPS, and enterprise business systems.

8. A system for deploying a software application, comprising:
a wireless device having a smart agent software application;
a server coupled to the wireless device using a browser software application, the server including a software program for creating an identity for a user and a group to provide for access to data, creating a GUI to provide for formatting, and mapping of the software application to the data, mapping the software application to external data using a drag and drop software application, formatting the data to the GUI using the drag and drop software application; and saving the group and user, the GUI and the mapping information in the server.

9. The system according to claim 8, wherein the GUI includes at least one screen configuration representing a presentation layer of the software application.

10. The system according to claim 8, wherein the software program includes a first subprogram that provides for messaging and alert notification, a second subprogram that provides for existing logic to be reused by the wireless device, a third subprogram that provides for the storage of data persisting in local memory, and a fourth subprogram that provides for mapping of the data and application functionality to a web service.

11. The system according to claim 9, wherein the at least one screen configuration is parsed to create a lowest common denominator file.

12. The method according to claim 11, wherein the lowest common denominator file is provided in XML format.

13. The method according to claim 9, wherein the at least one screen configuration is assigned to a wireless device.

14. The method according to claim 8, wherein the data emanates from a group including product databases, MQs, web services, GPS, and enterprise business systems.

15. A computer program product for use with a wireless device, the computer program product comprising:
a computer usable medium having computer readable program code embodied therein for use when deploying a software application on a wireless device having a smart agent software application and coupled to a server using a browser software application, the computer readable program code including:
computer readable program code for creating an identity for a user and a group to provide for access to data;
computer readable program code for creating a GUI to provide for formatting, and mapping of the software application to the data;
computer readable program code for mapping the software application to external data using a drag and drop software application;
computer readable program code for formatting the data to the GUI using the drag and drop software application; and
computer readable program code for saving the group and user, the GUI and the mapping information in the server.

16. The method according to claim 15, further comprising computer readable program code for providing for messaging and alert notification, for existing logic to be reused by the wireless device, for the storage of data persisting in local memory, and for mapping of the data and application functionality to a web service.

17. The method according to claim 15, wherein the GUI includes at least one screen configuration representing a presentation layer of the software application.

18. The method according to claim 17, further comprising computer readable program code for parsing the at least one screen configuration to create a lowest common denominator file.

19. The method according to claim 17, further comprising computer readable program code for assigning the at least one screen configuration to a wireless device.

20. A method for deploying a mobile application developed for coupling a wireless device to a server, in an online environment, comprising:
designing a wireless configuration including rules at the wireless device;
validating and storing the wireless configuration at the server;
compiling the rules in the server;
feeding the rules to a multithreaded engine;
executing rules at the multithreaded engine for at least one user; and
deploying the wireless application on the wireless device.

21. A method for communicating between a wireless device and a server, comprising:
registering an address of the wireless device with the server;
polling the server for an alert;
pushing an alert message to the wireless device;
synchronizing the transfer of data between the server and the wireless device;
placing the data in a queue on the wireless device; and
removing the data from the queue on the wireless device upon receipt of the data by the server.

22. The method according to claim 21, further comprising decrypting the data to provide information for GUI rendering on the wireless device.

23. The method according to claim 21, wherein the alert is associated with an action.

24. The method according to claim 21, wherein a user creates an alert and sends the alert with a predefined action.

25. The method according to claim 21, wherein all data to be transmitted between the server and the wireless device is routed through a security application.

26. The method according to claim 21, wherein the communication is accomplished over a network.

27. The method according to claim 26, wherein the network is at least one of a wireless network and a wired network.

28. The method according to claim 21, wherein the communication is accomplished using at least one of sockets and http/servlets.

29. The method according to claim 21, wherein the communication between the wireless device and the server is coordinated using a middleware application.

30. The method according to claim 29, wherein the middleware application is selected from a group including GSM, GPRS, 802.11, and iDEN.

31. A communications system, comprising:
a wireless device; and
a server communicating with the wireless device via a network, the wireless device including a software application that provides for registering an address of the wireless device with the server, polling the server for an alert, synchronizing the transfer of data between the server and the wireless device, placing the data in a queue on the wireless device, and removing the data from the queue on the wireless device upon receipt of the data by the server, and the server including a software application for pushing an alert message to the wireless device.

32. The system according to claim 31, wherein the software application further provides for decrypting the data to provide information for GUI rendering on the wireless device.

33. The system according to claim 31, wherein the alert is associated with an action.

34. The system according to claim 31, wherein a user creates an alert and sends the alert with a predefined action.

35. The system according to claim 31, wherein all data to be transmitted between the server and the wireless device is routed through a security application.

36. The system according to claim 31, wherein the communication is accomplished over a network.

37. The system according to claim 36, wherein the network is at least one of a wireless network and a wired network.

38. The system according to claim 31, wherein the communication is accomplished using at least one of sockets and http/servlets.

39. The system according to claim 31, wherein the communication between the wireless device and the server is coordinated using a middleware application.

40. The system according to claim 39, wherein the middleware application is selected from a group including GSM, GPRS, 802.11, and iDEN.

41. The system according to claim 31, further comprising a memory, the memory storing the data being accessed by the wireless device.

42. A computer program product for use with a communication system, the computer program product comprising:
a computer usable medium having computer readable program code embodied therein for use when facilitating communication between a wireless device and a server, the computer readable program code including:
computer readable program code for registering an address of the wireless device with the server;
computer readable program code for polling the server for an alert;
computer readable program code for pushing an alert message to the wireless device;
computer readable program code for synchronizing the transfer of data between the server and the wireless device;
computer readable program code for placing the data in a queue on the wireless device; and
computer readable program code for removing the data from the queue on the wireless device upon receipt of the data by the server.

43. The computer program product according to claim 42, further including computer readable program code for decrypting the data to provide information for GUI rendering on the wireless device.
